(19) United States
(12) Patent Application Publication
(10) Pub. No.: US 2009/0242120 A1
(43) Pub. Date: Oct. 1, 2009

(54) AUTOMOTIVE MASKING TAPE AND DISPENSERS

(75) Inventor: Biagio P. Pellegrino, Watervliet, NY (US)

Correspondence Address: LARSON NEWMAN & ABEL, LLP, 5914 WEST COURTYARD DRIVE, SUITE 200, AUSTIN, TX, 78730, US

(73) Assignees: SAINT-GOBAIN ABRASIVES, INC., Worcester, MA (US); Saint-Gobain Abrasifs, Conflans-Sainte-Honorine (FR)

(21) Appl. No.: 12/415,281

(22) Filed: Mar. 31, 2009

Related U.S. Application Data
(60) Provisional application No. 61/041,005, filed on Mar. 31, 2008.

(51) Int. Cl. B32B 7/10; B31B 1/62; B32B 37/02

(52) U.S. Cl. 156/324; 156/538; 156/556; 428/220

(57) ABSTRACT

A masking dispenser includes a vertical support, a paper roll, a fixture, and a reel. The paper roll support extends horizontally to the vertical support. The fixture includes a bracket coupled to an extension. The bracket is secured to the vertical support and the extension extends in a direction perpendicular to the paper roll support. The reel is rotatably coupled to the extension and is configured to receive a roll of masking tape and to dispense the masking tape parallel to an edge of a masking paper roll located on the paper roll support.

### CORRESPONDING APPLICATION

The present application claims priority from U.S. Provisional Patent Application No. 61/041,005, filed Mar. 31, 2008, entitled “AUTOMOTIVE MASKING TAPE AND DISPENSERS,” naming inventor Biagio P. Pellegrino, which application is incorporated by reference herein in its entirety.

### FIELD OF THE DISCLOSURE

This disclosure, in general, relates to automotive masking tape and dispensers.

### BACKGROUND

The automobile has become an integral part of modern societies. In particular, the average American household has two vehicles. Moreover, many spend a large amount of time in vehicles commuting to work and running errands. As a result, a large number of vehicles are on roads throughout the day and many are subject to automobile accidents. Accordingly, many vehicles utilize auto-body repaired.

Generally, after repairing damage to an automobile, the damaged area is repainted. Additionally, automobiles may be repainted to restore the finish, change the color, or to add decorative features. Regardless of the reason for applying the paint, portions of the automobile, such as the windows and chrome, are covered with masking tape or masking paper to prevent adhesion of the paint to these surfaces. After the paint is applied to the automobile, the paint requires time to dry or cure. While the curing can be done at ambient temperatures for extended periods of time, professional paint and body shops typically bake the automobile at elevated temperatures to reduce the time required to cure the paint.

Given the large number of automobiles and associated collisions, the paint supply industry, and in particular, the masking tape and masking paper market, has grown substantially. In a drive to handle the volume of paint and body repair, the automotive painting industry has turned to standardization of painting supplies and particularly, to standardized sizes of masking tape and masking paper rolls. Accordingly, a large infrastructure, including masking tape and masking paper dispensing machines configured to dispense standard sized masking tape and paper, has been established. As such, the aftermarket automobile paint industry has become rigid, adhering to standard sizes of masking paper and masking tape.

Unfortunately, such adherence to standards has lead to inefficiencies in the automobile painting industry. Such inefficiencies lead to slower throughput and higher labor costs

### SUMMARY

In an embodiment, a masking dispenser includes a vertical support, a paper roll support, a fixture, and a reel. The paper roll support extends horizontally from vertical supports. The fixture includes a bracket coupled to an extension. The bracket is secured to the vertical support. The extension extends in a direction perpendicular to the paper roll support. The reel is rotatably coupled to the extension. The reel is configured to receive a roll of masking tape and to dispense the masking tape parallel to an edge of a masking paper roll located on the paper roll support.

In another embodiment, a masking dispenser includes a masking paper roll support and a masking tape roll support. The masking paper roll support is configured to hold a masking paper roll having an initial paper radius. The masking paper roll support has a center axis around which the masking paper roll rotates. The masking tape roll support is configured to hold a masking tape roll having an initial tape radius. The masking tape roll support has a center axis around which the masking tape roll rotates. The center axis of the masking paper roll support and the center axis of the masking tape roll support are located apart by a distance of at least the sum of the initial paper radius and the initial tape radius. A vertical projection of the distance is less than the sum of the initial paper radius and the initial tape radius.

In a further embodiment, a merchandised article includes a fixture comprising a bracket coupled to an extension, a roll of masking tape, and text instructions on a support. The text instructions include instructions to secure the bracket of the fixture to a support of the masking dispenser such that the extension extends parallel to an edge of a masking paper roll located on the masking dispenser.

In yet another embodiment, a method of repairing a vehicle includes preparing a damaged surface of the vehicle to receive paint, dispensing a length of a masking sheet from a dispensing machine, and masking a portion of the vehicle by securing the length of the masking sheet to the vehicle using an adhesive strip. The masking sheet includes masking paper and masking tape secured to an edge of the masking paper and exposing the adhesive strip. The masking paper is drawn from a masking paper roll located in the dispensing machine. The masking tape is drawn from a masking tape roll located in the dispensing machine. The masking paper roll has an initial paper length not greater than 2.5 times the initial tape length of the masking tape roll.

In yet a further embodiment, a method of preparing a masking sheet includes inserting a masking paper roll into a dispensing machine, inserting a masking tape roll into the dispensing machine, and dispensing a length of a masking sheet. The masking paper roll includes an initial paper length of masking paper. The masking tape roll includes an initial tape length of masking tape and the initial paper length is not greater than 2.2 times the initial tape length. The masking sheet includes masking paper and masking tape secured to an edge of the masking paper. The masking tape presents an adhesive surface to secure the length of the masking sheet to a surface to be masked.

In another exemplary embodiment, a roll of masking tape includes a cylindrical support, and a strip of material. The strip of material includes a polymer coated fibrous substrate and a pressure sensitive adhesive coated on one side of the polymer coated fibrous substrate. The strip of material is co-radially wrapped around the circumference of the cylindrical support. The strip of material has a length of at least 100 meters and is temperature resistant to a temperature at least about 200° F.

In a further exemplary embodiment, a masking system to mask a surface of a vehicle to be painted includes a masking paper roll and masking tape roll. The masking paper roll includes masking paper wrapped around a cylindrical roll. The masking tape roll includes a cylindrical support and a masking tape. The masking tape includes a polymer coated fibrous substrate and a pressure sensitive adhesive coated on one side of the polymer coated fibrous substrate. The masking tape is co-radially wrapped around the circumference of the cylindrical support and the masking tape has a length of at least 0.4 times an initial paper length of the masking paper.

### BRIEF DESCRIPTION OF THE DRAWINGS

The present disclosure may be better understood, and its numerous features and advantages made apparent to those skilled in the art by referencing the accompanying drawings.

FIG. 1 is a schematic diagram illustrating an exemplary embodiment of a masking paper for automotive painting.

FIGS. 2 and 3 are schematic diagrams illustrating an exemplary embodiment of a masking tape for automotive painting.

FIG. 4 is a schematic diagram illustrating an exemplary embodiment of a masking dispenser.

FIG. 5 is a schematic diagram illustrating an adapter for use with a masking dispenser.

FIG. 6 is a schematic diagram illustrating an alternative embodiment of a masking dispenser.

FIG. 7 is a flow diagram illustrating an exemplary method of painting an automobile body.

The use of the same reference symbols in different drawings indicates similar or identical items.

### DETAILED DESCRIPTION

In a particular embodiment, a masking sheet is dispensed from a masking sheet dispensing machine. The masking sheet includes a sheet of masking paper and a length of masking tape disposed along at least one edge of the sheet of masking paper. At least part of the adhesive surface of the masking tape remains exposed in the masking sheet to adhere the masking sheet to a vehicle. Further, the masking paper and the masking tape are formed of materials that tolerate curing temperatures used in automotive painting. For example, the masking tape includes an adhesive that maintains its adhesiveness at temperatures up to 260° F. for 1 hour.

In an example, the masking sheet dispensing machine includes a paper roll support and a masking tape support. The masking tape support is to dispense masking tape parallel to an edge of the masking paper roll. Further, the masking sheet dispensing machine may be configured with more than one paper roll support, such as at least two, at least three, or even at least four paper roll supports. In addition, the masking sheet dispensing machine may be configured to dispense masking tape from more than one masking tape roll. For example, the masking sheet dispensing machine may be configured to dispense masking tape along two edges of the same paper roll. Alternatively, the masking sheet dispensing machine may be configured to dispense masking tape along an edge of each masking paper roll. In a particular embodiment, the masking sheet dispensing machine is configured to hold a masking paper roll having an initial paper length and a masking tape roll having an initial tape length in which the ratio of the initial paper length to the initial tape length is not greater than 2.5, such as in a range of 1.5 to 2.5, or a range of 1.9 to 2.2.

In particular, the masking sheet dispensing roll is configured to dispense masking paper having specific properties adapted for use in the automotive paint repair industry. For example, the masking paper is adapted to receive paint while limiting bleeding of the paint through the paper. Further, the masking paper maintains its integrity at temperatures of at least 200° F., such as up to 260° F. for 1 hour, and the masking paper resists paint flaking when removed from a masked surface after painting.

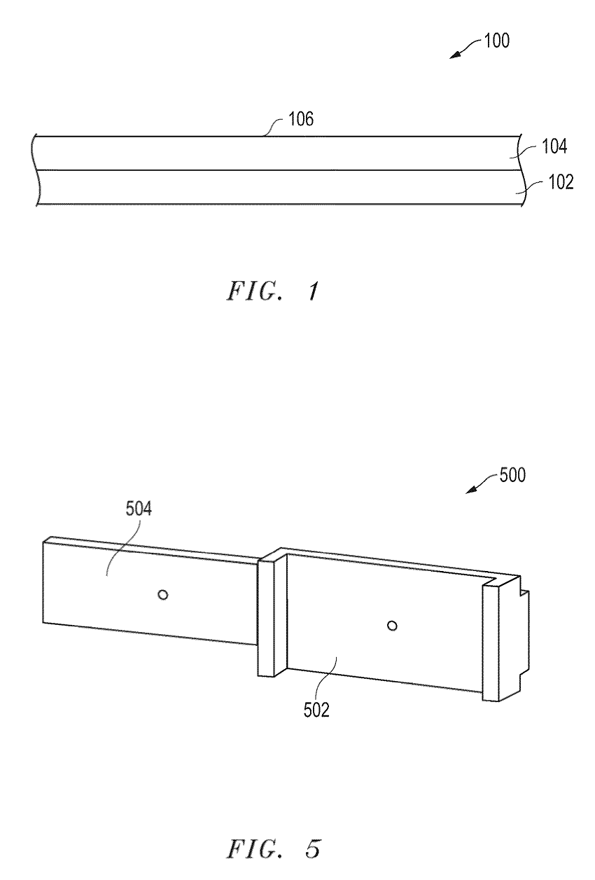

FIG. 1 illustrates an exemplary embodiment of masking paper 100 including a substrate 102 and a polymer layer 104 laminated to the substrate. The substrate 102 can be a paper-based product, such as pulp-based paper. The polymer layer 104 can be a polyethylene layer, such as a high-density polyethylene (HDPE) layer. Additionally, an outer surface 106 of the polymer layer 104 can be corona treated to increase surface roughness and improve paint adhesion. In addition, the masking paper 100 may be temperature resistant to at least about 200° F., preferably at least about 225° F., such as at least about 250° F., or even up to 260° F. for 1 hour. As such, the masking paper 100 can be substantially resistant to thermal degradation during baking to cure paint.

The masking paper 100 can be used to mask portions of an automobile body during painting to substantially prevent paint from adhering to portions of the automobile body covered by the masking paper 100. Increased surface roughness from corona treatment can increase paint adherence and reduce paint flaking when the paper is removed after painting.

Additionally, the masking paper 100 can be patterned to provide a way to test paint coverage. For example, the masking paper 100 can include a dark image on a light background. Paint can be test sprayed on the masking paper 100 to ensure that the paint and painting sprayer are set correctly to provide a paint layer sufficiently thick to prevent the dark image from showing through the paint layer.

In an exemplary embodiment, the masking paper is provided in a roll having an initial paper length of masking paper within a range of about 210 meters to about 240 meters. The masking paper 100 can be provided in multiple widths and multiple thicknesses.

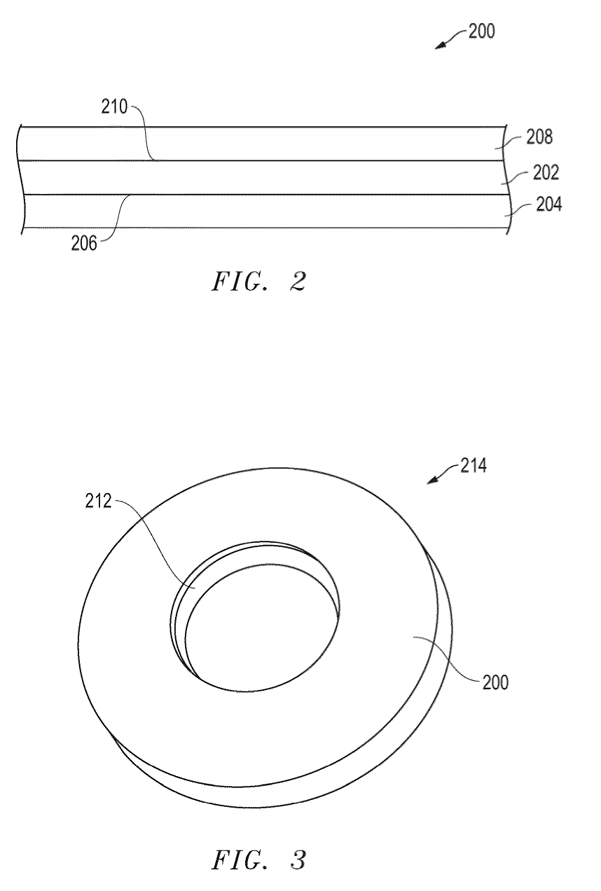

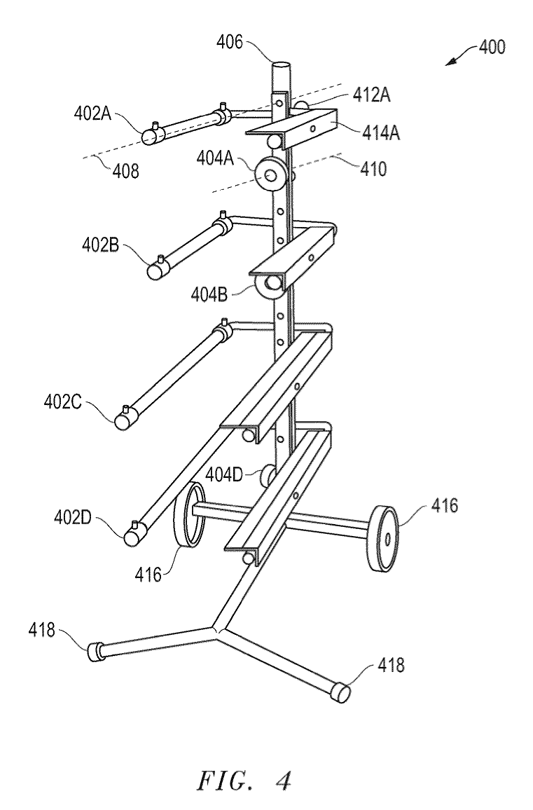

Similar to the masking paper, the dispensing machines may be configured to dispense masking tape having characteristics adapted for the automotive repair industry. FIGS. 2 and 3 illustrate an exemplary embodiment of a masking tape 200 including a substrate 202 and an adhesive layer 204. The substrate 202 can be a polymer coated fibrous substrate, such as pulp-based paper infused or coated with a polymer release agent. For example, a release layer 208 may be applied to or infused in the opposite surface 210 of the substrate 202 from the surface 206 on which the adhesive layer 204 is disposed to prevent the adhesive layer 204 from adhering to the opposite surface 210 when the masking tape 200 is on a roll. In an example, the release layer 208 is formed of a polymer, such as a polyolefin. In a further example, the fibrous substrate is a crepe paper.

The adhesive layer 204 can include a pressure sensitive adhesive, such as a rubber-based adhesive or a resin based adhesive, affixed to a surface 206 of the substrate 202. In an example, the adhesive layer may include a silicone-based adhesive. Typically, the pressure sensitive adhesive is not an acrylic-based adhesive. In contrast to many acrylic-based adhesives, the adhesive layer 204 maintains adhesiveness at baking temperatures, such as at least about 200° F., or even up to 260° F. for 1 hour.

In particular, the masking tape 200 can be used to affix the masking paper to an automobile body to substantially prevent paint from adhering to portions of the automobile body. As with masking paper 100, the masking tape 200 may be temperature resistant to at least about 200° F., preferably at least about 225° F., such as at least about 250° F., or even up to 260° F. for 1 hour. As such, the masking tape 200 can be substantially resistant to thermal degradation during baking to cure the paint.

The masking tape 200 can be provided in various widths, such as about 18 mm, about 36 mm and about 48 mm. Additionally, an initial tape length of masking tape 200, such as at least about 100 meters of masking tape, may be co-radially wrapped around the circumference of a cylindrical support 212 to provide a roll 214 of masking tape 200. Further, the masking tape may have an initial aspect ratio defined as the initial length divided by the width, of at least 2500, such as at least 3500, or even at least 5000.

Turning to the dispensing machine, FIG. 4 shows an exemplary embodiment of a masking dispenser 400. The masking dispenser 400 can include a paper roll support 402A and a tape reel 404A mounted on a vertical support. The paper roll support 402A can extend perpendicularly, such as horizontally, from the vertical support 406. The paper roll support 402A can be configured to support a masking paper roll and dispense the masking paper as the masking paper roll rotates around a paper center axis 408 of the paper roll support 402A. Similarly, the tape reel 404A can be configured to support a masking tape roll and dispense the masking tape as the masking tape roll rotates around a tape center axis 410 of the tape reel 404A. In particular, the masking tape is dispensed parallel to an edge of the masking paper roll.

Additionally, the masking dispenser 400 can include a guide 412A and a blade 414A to simultaneously sever a length of masking paper and masking tape, such as by cutting or tearing the masking paper and masking tape.

Further, the masking dispenser 400 can include reels 416 and feet 418. The reels 416 can aid in moving the masking dispenser 400 around a facility, such as around the automobile body, between automobile bodies, or to and from a storage location. The feet 418 can substantially prevent the masking dispenser 400 from tipping over when stationary.

The paper roll support 402A and the tape reel 404A can be arranged so that the masking tape is dispensed along the edge of or parallel to the masking paper. For example, as dispensed, a first portion of the masking tape can overlap an edge of the masking paper, such that the adhesive layer of the first portion adheres to the masking paper, while a second portion can be exposed, such that the adhesive layer of the second portion is available to adhere to the automobile body.

In an embodiment, the masking dispenser 400 can have more than one set of paper roll supports 402A-D and tape reels 404A-D, such as two, three or four sets. Additional sets can allow the dispensing of multiple rolls of paper. Further, the multiple rolls of paper may be of different widths. In addition, the masking dispenser 400 can include more than one masking tape roll to dispense making tape along two edges of a masking paper roll.

In an embodiment, a masking paper roll can include paper having a paper thickness and an initial paper length in a range of about 210 meters to about 240 meters, and the masking paper roll can have an initial paper radius. The initial paper radius can be related to the initial paper length and the paper thickness. A masking tape roll can include tape having a tape thickness and an initial tape length, and the masking tape roll can have an initial tape radius. In an example, the length of masking tape is at least about 100 meters, such as 110 meters. Additionally, the ratio of the initial paper length to the initial tape length can be in a range of about 1.5 to about 2.5, such as in a range of about 1.9 to about 2.2.

A distance greater than the sum of the initial paper radius and the initial tape radius can separate the paper center axis 408 and the tape center axis 410. The separation between the paper center axis 408 the tape center axis 410 can allow dispensing of a full roll of masking paper and a full roll of masking tape. Further, a vertical projection of the distance can be less than the sum of the initial paper radius and the initial tape radius, such as not greater than 0.95 times the sum of the initial paper radius and the initial tape radius.

In another embodiment, an adapter 500, shown in FIG. 5, can be provided to increase the distance between the paper center axis 408 and the tape center axis 410. In particular, the adapter 500 may increase the actual distance between the axes 408 and 410 while maintaining the vertical projection of the distance. In an example, the adapter 500 includes a bracket 502 for attaching to the masking dispenser 400 and an extension 504 for displacing the tape reel 404A in a direction perpendicular to the paper center axis 408. The adapter 500 can substantially maintain the vertical projection of the distance between the paper center axis 408 and the tape center axis 410 by displacing the tape center axis 410 along a substantially horizontal direction. The adapter 500 can allow the masking dispenser 400 to accommodate a masking paper roll having a greater paper thickness and thus a greater initial paper radius.

Additionally, the adapter 500 or the masking dispenser 400 may be provided with instructions to secure the adapter 500 to the masking dispenser 400 to displace the tape reel 404A and increase the distance between the paper center axis 408 and the tape center axis 410.

In a particular example, the adapter 500 may be bundled and sold with rolls of masking tape or rolls of masking paper. In an example, a merchandised article may include masking tape, the adapter, and the instructions described above. Further the merchandised article may include masking paper. In an additional example, the masking dispenser may be provided for free or complimentarily with a particular sized order of masking tape and masking paper.

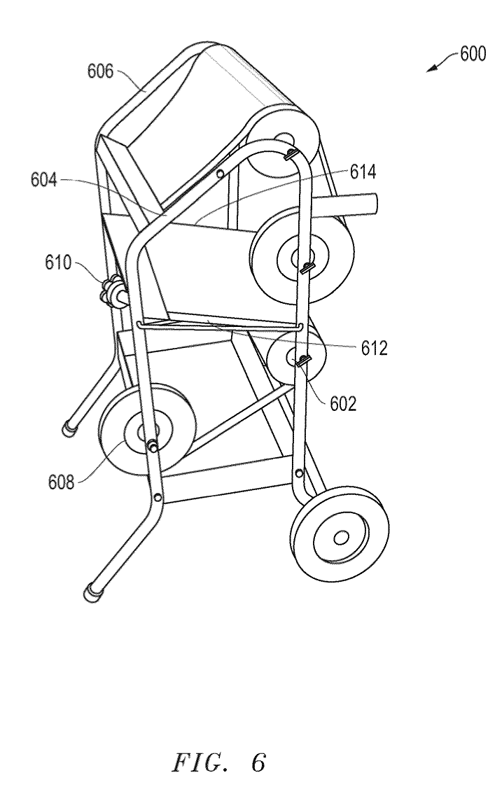

FIG. 6 illustrates an alternative embodiment of a masking dispenser 600. Masking dispenser 600 can include a paper roll support 602 extending between two vertical supports 604 and 606. Additionally, the masking dispenser 600 can have two tape reels 608 and 610 per paper roll support 602. A masking tape roll may be inserted onto either tape reel 608, tape reel 610, or both, allowing tape to be dispensed onto masking paper edge 612, masking paper edge 614, or both, respectively.

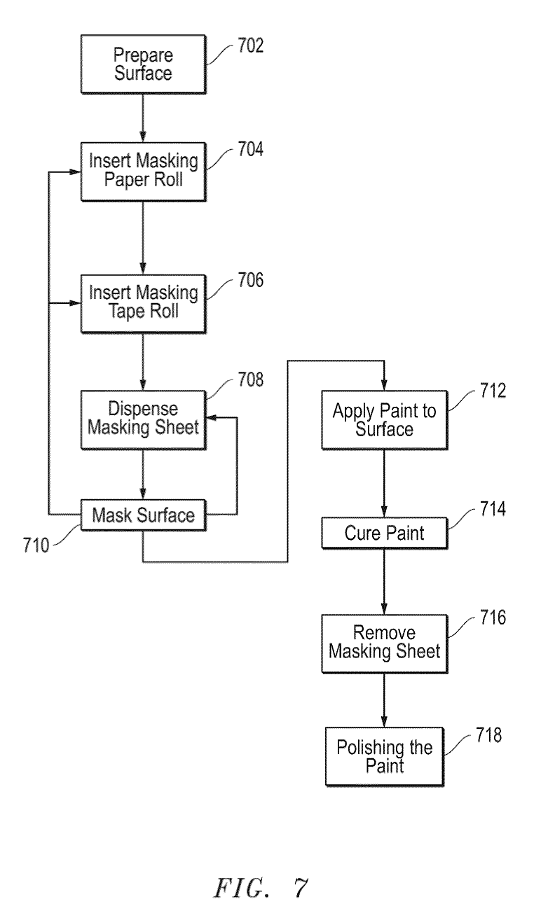

In use, the masking dispenser provides masking sheets that include the masking tape and the masking paper. FIG. 7 illustrates an exemplary method of painting an automobile body. As illustrated at 702, a damaged surface of the automobile body can be prepared. Preparing the surface may include removing the old paint, removing rust, and filling dents and holes with a filling compound, and the like. Preparing the surface may also include sanding and smoothing the surface. As illustrated at 704, a masking paper roll can be inserted onto a paper roll support of a masking dispenser. The masking paper can be threaded over a guide and past a blade. In addition, a masking tape roll can be inserted onto a tape reel of a masking dispenser, as illustrated at 706. The masking tape can be threaded around the paper roll, parallel to an edge of the paper roll, such that a portion of the adhesive layer overlaps the masking paper and a portion of the adhesive layer is exposed. Additionally, the masking tape can be threaded over a guide and past a blade. In an alternative embodiment, the masking paper roll and the masking tape roll may be inserted onto masking dispenser prior to preparing the surface of the automobile body.

As illustrated at 708, a masking sheet can be dispensed. A masking sheet can include the masking paper and the masking tape aligned with an edge of the masking paper such that a portion of the adhesive layer is exposed. Alternatively, a masking sheet can include two lengths of masking tape, each aligned with an opposite edge of the masking paper such that a portion of the adhesive layer of each length of masking tape is exposed. When a desired length of the masking sheet is dispensed, the masking sheet can be cut or torn from the dispenser, such that the masking paper and the masking tape are substantially simultaneously severed from the masking paper roll and the masking tape roll respectively.

As illustrated at 710, the masking sheet can be applied to the surface of the automobile body such that a portion of the surface is masked. Additional masking sheets may be dispensed from the masking dispenser to provide adequate coverage of the masked portions of the automobile body. Further, additional rolls of masking paper or masking tape to be inserted onto the masking dispenser to provide adequate lengths of masking sheet.

In an example, paint can be applied, such as by spraying, to the unmasked surface of the automobile body, as illustrated at 712. As illustrated at 714, the paint may be cured, such as by drying at ambient temperature for an extended period of time or baking at an elevated temperature for a shortened period of time. In particular, the paint may be cured at temperatures of at least 200° F., or even up to 260° F. for 1 hour. As illustrated at 716, the masking sheet can be removed from the automobile body, and as illustrated at 718, the paint is polished. For example, the pain may be sanded and polished to provide a desired finish. As a result, an automobile may be repaired, and the paint may appear uniform on surfaces on which the paint is desired and may be absent from surfaces on which the paint is not desired.

As a result of standardizing, the automotive painting industry became rigid and inflexible, leading to inefficiencies. Particular embodiments described above provide advantageous technical features that lead to improved efficiency in automotive painting. Such improvements in efficiency have long been desired by the industry and as a result, embodiments described herein are in great demand, representing commercial success.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A masking dispenser comprising:
a vertical support;
a paper roll support extending horizontally between and coupled to the vertical support;
a fixture including a bracket coupled to an extension, the bracket secured to the vertical support, the extension extending in a direction perpendicular to the paper roll support; and
a reel rotatably coupled to the extension, the reel to receive a roll of masking tape and to dispense the masking tape parallel to an edge of a masking paper roll located on the paper roll support.

2. The masking dispenser of claim 1, wherein the fixture is to accommodate the roll of masking tape and the paper roll support is to accommodate the masking paper roll without the roll of masking tape and the masking paper roll interfering with each other, an initial length of paper on the masking paper roll being in a range of 210 meters and 240 meters and a ratio of the initial length of the masking paper roll to an initial length of masking tape on the masking tape roll being in a range of 1.5 to 2.5.

3. The masking dispenser of claim 2, wherein the ratio is in a range of 1.9 to 2.2.

4. The masking dispenser of claim 1, further comprising:
a second fixture including a second bracket and a second extension, the second extension extending in a direction perpendicular to the paper roll support; and
a second reel rotatably coupled to the second extension, the second reel to receive a second roll of masking tape.

5. The masking dispenser of claim 4, further comprising a second vertical support, wherein the second bracket is secured to the second vertical support.

6. The masking dispenser of claim 4, wherein the second bracket is secured to the vertical support.

7. The masking dispenser of claim 1, further comprising a second paper roll support extending horizontally from and coupled to the vertical support.

8.-22. (canceled)

23. A method of preparing a masking sheet, the method comprising:
inserting a masking paper roll including an initial paper length of masking paper into a dispensing machine;
inserting a masking tape roll including an initial tape length of masking tape into the dispensing machine, the initial paper length not greater than 2.5 times the initial tape length; and
dispensing a length of a masking sheet, the masking sheet including masking paper and masking tape secured to an edge of the masking paper, the masking tape presenting an adhesive surface to secure the length of the masking sheet to a surface to be masked.

24. The method of claim 23, wherein inserting the masking tape roll comprises applying the masking tape roll to a reel rotatably coupled to an extension of a fixture secured to a support of the dispensing machine, the extension extending parallel to the edge of the masking paper.

25. The method of claim 23, wherein the masking paper comprises a polymer coated paper.

26. The method of claim 23, wherein the initial paper length is at least 200 meters.

27. The method of claim 23, wherein the initial paper length is between 1.9 times and 2.2 times the initial tape length.

28. The method of claim 23, wherein the masking tape includes a polymer coated fibrous substrate and a pressure-sensitive adhesive.

29. The method of claim 23, further comprising masking a surface of a vehicle with the masking sheet by adhering the adhesive surface to the surface to be masked.

30. The method of claim 23, further comprising inserting a second masking tape roll having the initial tape length into the dispensing machine.

31. A roll of masking tape comprising:
a cylindrical support; and
a strip of material comprising a polymer coated fibrous substrate and a pressure sensitive adhesive coated on one side of the polymer coated fibrous substrate, the strip material co-radially wrapped around the circumference of the cylindrical support, the strip of material having a length of at least 100 meters and being temperature resistant to a temperature not less than about 200° F.

32. The roll of claim 31, wherein the length is in a range of 100 meters to 120 meters.

33. A masking system to mask a surface of a vehicle to be painted, the masking system comprising:
a masking paper roll including masking paper wrapped around a cylindrical roll; and
a masking tape roll comprising:
a cylindrical support; and
a masking tape comprising a polymer coated fibrous substrate and a pressure sensitive adhesive coated on one side of the polymer coated fibrous substrate, the masking tape co-radially wrapped around the circumference of the cylindrical support, an initial paper length is not greater than 2.5 times an initial length of the masking tape.

34. The masking system of claim 33, further comprising a dispenser including at least one bar to rotatably support the masking paper roll and including at least one reel to rotatably support the masking tape roll.

35. The masking system of claim 34, wherein the at least one bar and the at least one reel are positioned to dispense the masking tape along an edge of the masking paper, at least a portion of the masking tape secured to the masking paper and at least a portion of the adhesive of the masking tape being exposed.

36. The masking system of claim 35, further comprising a guide and a blade to simultaneously severe a length of masking tape and masking paper from the masking tape roll and masking paper roll.
